(19) United States
(12) Patent Application Publication
(10) Pub. No.: US 2012/0042113 A1
(43) Pub. Date: Feb. 16, 2012

(54) MOBILE COMPUTING APPLIANCE FOR HOSTING A PORTABLE, BOOTABLE MEDIUM

(76) Inventor: ROBERT LEE, Winchester, CA (US)

(21) Appl. No.: 13/184,380

(22) Filed: Jul. 15, 2011

Related U.S. Application Data
(60) Provisional application No. 61/373,203, filed on Aug. 12, 2010.

(51) Int. Cl. G06F 13/20

(52) U.S. Cl. 710/313

(57) ABSTRACT

A portable computing hub appliance is configured to host a portable, bootable data storage medium, such as a USB flash, spinning device or compact disk having an operation system image saved thereupon. The appliance may not have a hard drive, operating system, or any other overhead that is typically found on a PC, Mac or tablet PC. The appliance may include the minimum components needed to host the portable, bootable medium, such as a USB flash, spinning drive, or compact disk with a Windows® or other operating system. The appliance may provide a user with the ability to boot any portable, bootable medium, such as a USB flash, spinning drive, or compact disk, eliminating security concerns caused by giving users access to the BIOS configurations or system hard drive. The appliance may include a power supply, an optional external Wi-Fi antenna port, audio input and output ports, an internal processor, an optional internal battery, an optional touchscreen, and the like.

### CROSS-REFERENCE TO RELATED APPLICATIONS

This application claims the benefit of priority to U.S. Provisional Patent Application No. 61/373,203, filed Aug. 12, 2010, the contents of which are herein incorporated by reference.

### BACKGROUND OF THE INVENTION

The present invention relates to information technology and, more particularly, to a portable appliance without an operating system that hosts a portable, bootable medium, such as a universal serial bus (USB) flash, spinning drive or compact disk, having an operating system image, and without having to configure the basic input/output system (BIOS) settings.

Currently, a user is required to use a portable, bootable medium, such as a USB flash, spinning drive, or compact disk, with a personal computer (PC) or Mac machine desktop or laptop computer. This is often bulky equipment for mobile users to carry. PC's and Macs also include overhead components, such as hard drives with an Windows® or other operating system, that are not needed to host a portable, bootable medium such as a USB flash, spinning drive, or compact disk having an operating system image stored thereupon.

Additionally, because of the number of BIOS manufacturers, all the possible BIOS configurations cannot be addressed, making the necessary BIOS setting changes complicated for booting from the USB, or other medium. Moreover, the user would have to have access to the BIOS settings. If the BIOS is password protected, the user must know the password or have access to someone who does.

Accessing the BIOS is normally accomplished by a number of key strokes, independent to each manufacturer. When a user does not have permission to access the BIOS settings on the machine needed to boot portable bootable medium such as a USB flash, spinning drive, or compact disk, such as at an internet café, hotel, or library), the user will be unable to use the portable bootable medium.

As can be seen, there is a need for a portable appliance that may host a portable bootable medium, such as a USB flash drive, spinning drive or compact disk having an operating system stored thereupon.

### SUMMARY OF THE INVENTION

In one aspect of the present invention, a computing appliance comprises a shell encasing an internal processor operatively connected to an input/output chipset; and a plurality of universal serial bus (USB), and other ports provided in the shell, the ports operatively connected to the input/output chipset, wherein the computing appliance lacks an internal hard drive, and operating system, and lacks connectivity to the same; and the internal processor interfaces with an operating system provided by a user on a portable, bootable data storage medium.

These and other features, aspects and advantages of the present invention will become better understood with reference to the following drawings, description and claims.

### BRIEF DESCRIPTION OF THE DRAWINGS

FIG. 1 is a perspective view of a portable, bootable medium hub appliance according to an exemplary embodiment of the present invention;

FIG. 2 is a front view of the portable, bootable medium hub appliance of FIG. 1;

FIG. 3 is a rear view of the portable bootable medium hub appliance of FIG. 1;

FIG. 4 is a top view of the portable bootable medium hub appliance of FIG. 1;

FIG. 5 is a perspective view of a mobile portable bootable medium hub appliance according to another exemplary embodiment of the present invention;

FIG. 6 is a front view of the mobile portable bootable medium hub appliance of FIG. 5;

FIG. 7 is a rear view of the mobile portable bootable medium hub appliance of FIG. 5;

FIG. 8 is a top view of the mobile portable bootable medium hub appliance of FIG. 5;

FIG. 9 is a perspective view of a portable bootable medium hub appliance according to another exemplary embodiment of the present invention;

FIG. 10 is a front view of the portable bootable medium hub appliance of FIG. 9;

FIG. 11 is a rear view of the portable bootable medium hub appliance of FIG. 9;

FIG. 12 is a top view of the portable bootable medium hub appliance of FIG. 9;

FIG. 13 is a perspective view of the portable bootable medium hub appliance of FIG. 9 with its flip-top in an open position; and

FIG. 14 is a schematic block diagram of the portable bootable medium hub appliance according to various exemplary embodiments of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a portable appliance that may host a portable, bootable data storage medium, such as a USB flash, spinning device, or compact disk having an operating system image saved thereupon. The appliance may not have a hard drive or any other overhead that is typically found on a PC, Mac or tablet PC. The appliance may include the minimum components needed to host the portable, bootable medium, such as a USB flash, spinning drive, or compact disk with a Windows® or other operating system. The appliance may provide a user with the ability to boot any portable bootable medium, such as a USB flash, spinning drive, or compact disk eliminating security concerns caused by giving users access to the BIOS configurations or system hard drive. The appliance may include a power supply, an optional external Wi-Fi antenna port, audio input and output ports, an internal processor, an optional internal battery, an optional touchscreen, and the like.

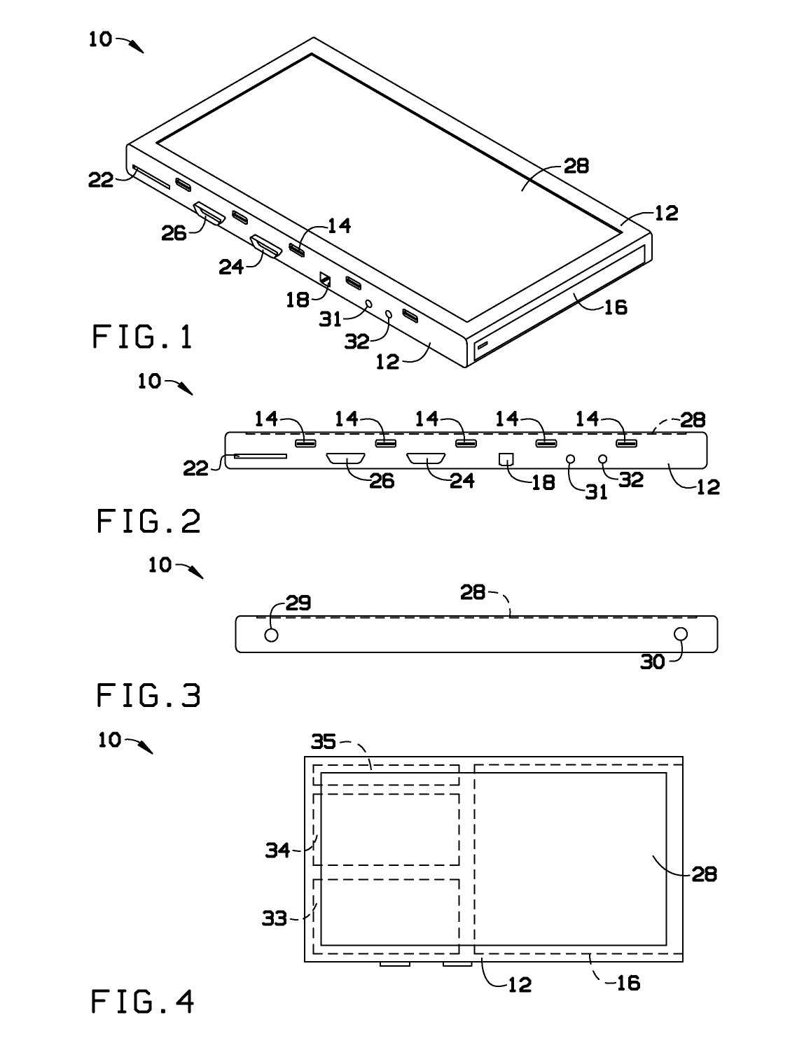

Referring now to FIGS. 1 through 4, a computing appliance 10 may include a shell 12 having a plurality of interface ports formed therein. The interface ports may include a plurality of USB ports 14, an Ethernet 10/100 port 18, a smart card/PCMCIA reader 22, a 15-pin analog video output 24, an HDMI video output 26, a power supply/recharge port 29, an external Wi-Fi antenna port 30, an audio input port 31 and an audio output port 32. While the Figures show these interface ports in certain locations on the shell 12 of the appliance 10, the locations of the interface ports may be disposed in different positions. For example, the USB ports 14 may be disposed not only on one side of the appliance 10, but on multiple sides of the appliance.

A touch screen 28 may be disposed on one surface of the shell 12. The touch screen 28 may be used to provide a method for data entry or may be used to provide menu driven options for using the portable, bootable medium. For example, a user may use the touch screen 28 as a touch keyboard and/or a monitor. In other embodiments, an external keyboard and/or an external monitor (not shown) may be connected to the appliance 10 various the designated interface ports.

An optional CD/DVD drive 16 may be disposed in the shell 12. The drive 16 may be used to run portable, bootable medium or may be used for inputting data or for writing and saving data.

An internal processor 34 may be disposed inside the shell 12. The internal processor 34 may be a central processing unit (CPU), typically a dual core or higher CPU. An internal input/output chipset 33 may be disposed in the shell 12. The chipset 33 may be used to drive and support connectivity to the different input/output devices that may be plugged into the appliance 10. The chipset 33 and the processor 34 may be used, along with internal memory (not shown), such as random access memory (RAM), typically at least 4 gigabytes RAM, to permit the appliance 10 to function as a computing device when connected to a portable, bootable medium, such as a USB flash, spinning drive, or compact disk. An internal battery 35 may be disposed inside the shell 12. The internal battery 35 may be charged via the power supply/recharge port 29. The internal battery 35 may power the appliance 10 when it is not connected to an appropriate power supply. A power button (not shown) may be disposed to allow a user to turn on and off the appliance 10.

The USB ports 14 may be used to support various USB devices, such as a USB mouse, USB monitor, USB keyboard, external USB storage device, or the portable, bootable USB flash or spinning drive, and the like.

As discussed above, the appliance 10 may not include overhead components, such as a hard drive, or operating system. The appliance 10 may be a portable device carried by a user and used for portable computing, and accessing portable, bootable mediums. In some embodiments, the appliance 10 may be used in an internet café, hotel, library, or the like. In these cases, the appliance 10 may be secured to a work area and may be connected to a monitor, mouse and keyboard, for example.

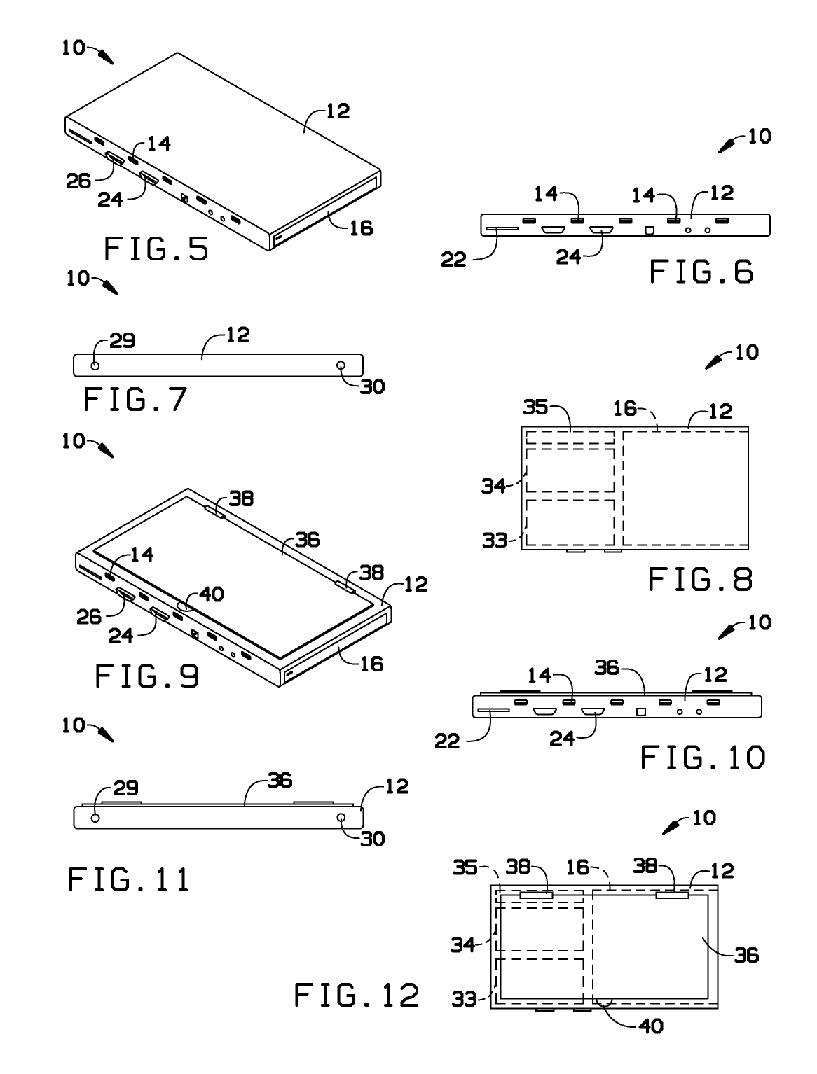

Referring now to FIGS. 5 through 8, in an alternate embodiment, the appliance 10 may be the same as that shown in FIGS. 1 through 4, except that a touchscreen 28 may not be provided.

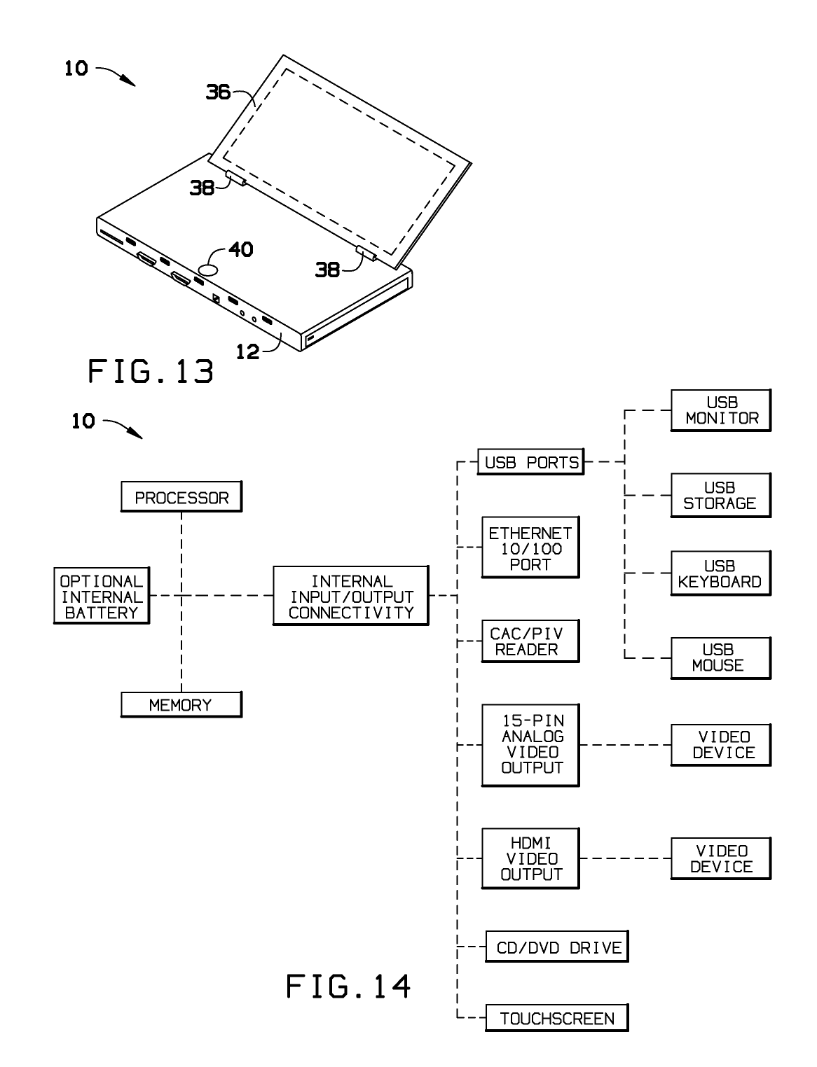

Referring now to FIGS. 9 through 13, the appliance 10 may be the same as that shown in FIGS. 1 through 4, except that a flip-top 36 may be attached, via hinges 38, to the shell 12. The flip-top 36 may open to provide a video screen (shown by dotted lines in FIG. 13) similar to a conventional laptop computer.

It should be understood, of course, that the foregoing relates to exemplary embodiments of the invention and that modifications may be made without departing from the spirit and scope of the invention as set forth in the following claims.

What is claimed is:

1. A computing hub appliance comprising:
a shell encasing an internal processor operatively connected to an input/output chipset; and
a plurality of universal serial bus (USB) ports provided in the shell, the USB ports operatively connected to the input/output chipset, wherein
the computing hub appliance lacks connectivity to a hard drive and operating system; and
the internal processor interfaces with an operating system provided by a user on a portable bootable data storage medium.

2. The computing hub appliance of claim 1, further comprising a CD/DVD drive contained within the shell.

3. The computing hub appliance of claim 1, further comprising an Ethernet 10/100 port.

4. The computing hub appliance of claim 1, further comprising a smart card/PCMCIA reader.

5. The computing hub appliance of claim 1, further comprising at least one video output port.

6. The computing hub appliance of claim 1, further comprising a touch screen formed in at least a portion of one side of the shell.

7. The computing hub appliance of claim 1, further comprising an internal battery.

8. The computing hub appliance of claim 1, further comprising a flip top hingedly attached to the shell.

9. The computing hub appliance of claim 1, further comprising audio input and output ports.

10. The computing hub appliance of claim 1, further comprising an external Wi-Fi antenna port.
